(19) United States
(12) Patent Application Publication
(10) Pub. No.: US 2013/0192934 A1
(43) Pub. Date: Aug. 1, 2013

(54) SPRING PRESSURE BRAKE HAVING A MAGNET HOUSING

(71) Applicant: Kendrion (Aerzen) GmbH, Aerzen (DE)

(72) Inventor: Rolf Knop, Extertal (DE)

(73) Assignee: Kendrion (Aerzen) GmbH, Aerzen (DE)

(21) Appl. No.: 13/752,753

(22) Filed: Jan. 29, 2013

(30) Foreign Application Priority Data
Jan. 31, 2012 (DE) 202012000897.8

(51) Int. Cl. F16D 63/00; F16D 55/224

(52) U.S. Cl. CPC F16D 63/002; F16D 55/224
USPC 188/72.3

(57) ABSTRACT

A spring pressure brake (1) has a magnet housing (2) with an annular space or an annular groove (3) for receiving an electromagnetic coil 4. The magnet housing (2) is formed of two parts, the first part 14 of which has the annular space (3) and is made of magnetizable sintered metal, that is to say forms a pot magnet. The second part (15) of the magnet housing (2) encloses a part region of the first part (14) and in the process also its end side (14a) and is made of a non-magnetizable material, the specific weight of which is lower than that of the material of the first part or pot magnet (14). Magnetic losses can therefore be reduced or avoided and weight can be saved.

### INCORPORATION BY REFERENCE

The following documents are incorporated herein by reference as if fully set forth: German Patent Application No.: 202012000897.8, filed Jan. 31, 2012.

### BACKGROUND

The invention relates to a spring pressure brake having a magnet housing which has an annular receiving space for an electromagnetic coil and can be connected by fastening screws to a housing of a drive, having a non-rotatable armature disk which is arranged coaxially with respect to the electromagnetic coil and is made from magnetically conducting material, having a rotor disk which is arranged coaxially with respect to the armature disk and serves as brake disk, and having a non-rotatable mating disk which serves as abutment for the brake or rotor disk, the spring pressure brake having a central compression spring or individual compression springs which are arranged at a radial spacing from the longitudinal center axis in order to generate the brake pressure between the armature disk, brake disk and mating disk when current is not applied to the electromagnetic coil, and fastening screws being provided for connecting the magnet housing to a holding device, a housing or a flange for the mating disk.

A spring pressure brake of this type is known from DE 102006010656 B3 and has proven itself.

A comparable spring pressure brake is known from DE 4031245 A1.

A comparable spring pressure brake is likewise known from DE 198 38 171 A1. Here, the pot magnet which can be magnetized and to this end receives the electromagnetic coil has a flange which is connected integrally to it and is penetrated by fastening screws which at the same time penetrate a plastic sleeve which belongs to the housing of said spring pressure brake and is arranged coaxially with respect to the pot magnet.

Above all in the cases, in which the spring pressure brake is to have comparatively small or low dimensions, because only a limited space is available to accommodate it, the weight of spring pressure brakes which are constructed in this way in a known manner is relatively high. Moreover, there are frequently leakage fluxes and magnetic losses at the magnet housing, above all. Losses of this type can be produced as a result of the fact that the fastening of the spring pressure brake itself also has to act on the magnet housing, that is to say the abovementioned fastening screws are provided, as is known, for example, from DE 198 38 171 A1 which is mentioned above. Moreover, the radially outwardly oriented flange of the magnet housing requires additional space in the radial direction.

Moreover, the compression springs can require additional space, in particular in the case of an arrangement at a radial spacing from the longitudinal center axis, as a result of which the magnet housing is enlarged, which in turn can increase the risk of leakage fluxes and magnetic losses.

### SUMMARY

It is therefore the object to provide a spring pressure brake of the type defined at the outset, in which the risk of magnetic or leakage losses can be reduced or avoided as far as possible.

In order to achieve this object, the spring pressure brake which is defined at the outset is distinguished by the fact that at least the magnet housing consists of at least two parts, the first part of which has, as pot magnet, the annular receiving space for the magnetic coil and which is comprised of magnetizable material, and that the second part of the magnet housing is connected to the first part, has the fastening points for the fastening screws and is comprised of a non-magnetizable material, that second part of the magnet housing which is comprised of non-magnetizable material having, on its outer circumference, holes or projections or cross-sectional widened portions which are oriented in the axial direction for the fastening screws, and that the first part of the magnet housing is bore-free or hole-free in the sense that it is not loaded by the fastening screws.

The result of the surprising assembly of the magnet housing firstly from the pot magnet made from magnetizable material and secondly a further part made from non-magnetizable material is a reduction in the magnetizable mass, with the result that the risk of leakage fluxes and/or magnetic losses is correspondingly reduced or even avoided.

The reduced mass of magnetizable material results in the additional advantage that the spring pressure brake according to the invention can react more rapidly to the current for the electromagnetic coil being switched on or off, because a smaller volume has to be magnetized or demagnetized. The installed coil rating can be correspondingly lower, which can have cost advantages and also weight advantages. This results further in short switching on and off times. Since, according to the invention, the fastening screws act on the second part of the magnet housing and the first part is therefore bore-free and hole-free with regard to fastening screws of this type, it does not have to be dimensioned in such a way that there is space for holes for fastening screws.

One particularly expedient and advantageous refinement of the spring pressure brake according to the invention can provide that that second part of the magnet housing which is connected to the pot magnet is comprised of a material which has a lower specific weight than the material of the first part of the magnet housing, that is to say of the pot magnet. Since the magnet housing is therefore comprised partially of lighter material, the overall weight of the magnet housing can be reduced correspondingly.

Due to its shape and its dimensions, the non-magnetizable second part of the magnet housing which is comprised of a lighter material than the pot magnet or the first part of the magnet housing can have a lower weight than the first part of the magnet housing. It can be assumed here that the overall volume of the material of the second part of the magnet housing is smaller than the volume of the first part or of the pot magnet, with the result that, just for this reason, the overall weight of the non-magnetizable second part of the magnet housing is considerably lower than that of the first part on account of the different specific weights. In every case, the overall weight is reduced with respect to a spring pressure brake, the magnet housing of which is comprised practically completely of magnetizable material.

Despite this production according to the invention of the magnet housing from at least two different materials, a central compression spring or individual compression springs which are arranged at a radial spacing from the longitudinal center axis of said spring pressure brake and of its magnet housing can expediently press the brake disk against the mating disk or the armature disk against the brake disk and, as a result, the brake disk against the mating disk when current is not applied to the electromagnetic coil.

The non-magnetizable material of the second part of the magnet housing can be a material which can be injection molded, in particular plastic or aluminum. The overall production is simplified as a result.

It is possible that that first part of the magnet housing which is comprised of magnetizable material and the second part of the magnet housing are connected to one another by injection molding if a material which is correspondingly capable of being injection molded forms the second part. Any possible additional fastening operations or fastening elements can therefore be avoided.

At least on the outer side or circumferential side of the first magnetizable part of the magnet housing, at least one region which differs from the contour of this outer side, in particular from a round or cylindrical contour of said outer side or a plurality of regions of this type can be provided which engages/engage or is/are embedded into the non-magnetizable material of the second part from the inside in the use position. A projection or a depression or a region of the same type which differs from a smooth contour can therefore be provided on the outside on an as a rule cylindrical pot magnet, in particular on its circumference, but also possibly on its end side, which projection or depression or region of the same type which differs from a smooth contour is enclosed by the material of the second part, with the result that the two parts are connected in a rotationally fixed and preferably positively locking manner, which results in a stronger connection than if the second part engages around a smooth outer side of the first part. This also optionally makes a longer service life possible, above all if said spring pressure brake is used in applications which are susceptible to vibrations or are loaded dynamically.

A further refinement of the invention for saving weight can provide that that second part of the magnet housing which is comprised of non-magnetizable material has at least one or more interruptions on that end side of the pot magnet which is covered or engaged over by it, on its side which faces away from the armature disk. As a result of interruptions of this type, the quantity of the material of the second part of the magnet housing can be reduced. Here, said interruptions have the further advantage that the dissipation of heat from the magnetizable part is aided.

A further possibility is provided in that the electric feed line to the electromagnetic coil runs through an end-side interruption of the second part of the magnet housing. The magnetizable first part of the magnet housing can be comprised of sintered metal. This has the advantage that recourse can be made during the production of said first part of the magnet housing to a technique which has proven itself for pot magnets.

A special holding device or a flange or a mounting of this type is expediently provided for the mating disk which interacts with the brake disk. Here, one refinement of the invention can provide that said holding device, which can be connected or is connected in the use position to the magnet housing, for the mating disk is comprised of a non-magnetizable material, in particular from a material, the specific weight of which is lower than that of steel or magnetizable sintered metal. The concept of saving weight and ruling out leakage losses as far as possible is therefore also applied to or realized with said holding device for the mating disk of the spring pressure brake.

It is possible here that the holding device for the mating disk is configured as a cover or housing part which, in its interior, contains the mating disk arranged concentrically with respect to the longitudinal center axis and is connected to the magnet housing in the use position via fastening screws and/or via the fastening screws for the spring pressure brake and is comprised of plastic or aluminum, preferably from the same material as the second part of the magnet housing. This holding device, which is preferably configured as a cover or housing, for the mating disk can optionally be fixed by way of fastening screws which are provided specially for it or optionally additionally by way of the fixing screws which are also provided for the mounting of the spring pressure brake, for example, on an engine housing.

A further refinement of the spring pressure brake according to the invention, in particular of one with a holding device for the mating disk, can provide that this holding device for the mating disk has at least one opening which runs in the axial direction at the circumference of the spring pressure brake for a projection, engaging radially therein, of the armature disk, and that the holding device also holds the armature disk in its use position as a result. Here, this opening is dimensioned to be sufficiently large in the axial direction, in order to give the armature disk the axial freedom of movement which is required for its function. As a result, the holding device for the mating disk is given an additional function, since it ensures the fixing of the armature disk in the rotational direction, with the result that no other, possibly complicated measures are necessary to make the armature disk rotationally fixed or non-rotatable.

It is expedient for a symmetrical and balanced arrangement if the holding device for the mating disk has at least two openings, lying opposite one another on the circumference of the arrangement, for two projections of the armature disk which are aligned with one another. The armature disk can therefore expediently have two regions or projections which project radially with respect to its circumference, engage in the use position into the openings of the holding device which are arranged in a matching manner thereto and lie opposite one another, and result in correspondingly balanced and symmetrical absorption of a torque which acts on the armature disk in the case of braking.

That second part of the magnet housing which is also arranged on the end side of the pot magnet and is made from non-magnetizable material can have a central opening coaxially with respect to the longitudinal center axis of the pot magnet and with respect to a central opening which penetrates it and the circular cross section or diameter of which is smaller than that of the central opening of the spring pressure brake, and that annular region of the second part which projects radially into the region or cross section of the central opening can form a supporting face for a central compression spring. It is therefore possible to provide the second part of the magnet housing in the region of the central opening of the pot magnet with an opening which is narrower than the central opening, it optionally being possible for said second part to cover the central opening of the pot magnet even completely, in order to support the central compression spring of a spring pressure brake of this type.

Above all, a combination of individual or several ones of the above-described features and measures results in a spring pressure brake, in which, as a result of the division of the magnet housing, the mass of magnetizable material can be reduced and overall the weight can also be lowered, with the result that magnetic losses, leakage fluxes or leakage losses in the region of the electromagnetic coil and of the pot magnet can be avoided as far as possible or optionally even completely. This can be assisted by the fact that the flange or the holding device for the mating disk is also comprised of a non-magnetizable material of the type, as is provided for the second part of the magnet housing. Here, at the same time, the holding device for the mating disk which serves as abutment for the brake disk can be used to grip the armature disk positively on its circumference and to make it non-rotatable as a result.

### BRIEF DESCRIPTION FO THE DRAWINGS

In the following text, one exemplary embodiment of the invention is described in greater detail using the drawing, in which, in a partially diagrammatic illustration:

FIG. 1 shows a longitudinal section through a spring pressure brake according to the invention, the magnet housing of which is assembled from two parts which are made from different materials,

FIG. 2 shows a diagrammatic view of the end side, to be connected to a drive, of the spring pressure brake according to the invention in the premounted state,

FIG. 3 shows a diagrammatic illustration of the spring pressure brake according to the invention with a view of the end side which faces away from a drive, it being possible to see the apertures on the second part of the magnet housing which expose parts of the pot magnet,

FIG. 4 shows a longitudinal section through the magnet housing which consists of two parts of different materials, with the pot magnet which has an annular groove for an electromagnetic coil and is comprised of sintered iron, and with the second part which is comprised of non-magnetizable material and has holes for fastening screws,

FIG. 5 shows a diagrammatic view of the magnet housing with a view of the end side which is shown in FIG. 3,

FIG. 6 shows a diagrammatic illustration of the magnet housing which is shown in FIG. 4, with a view of the annular groove which is provided on the pot magnet,

FIG. 7 shows a longitudinal section of a mating disk which serves as abutment for the brake disk, and of its housing-like holding device which is comprised of non-magnetizable material,

FIG. 8 shows a diagrammatic illustration of the holding device according to FIG. 7 with the mating disk which is arranged in its interior, and

FIG. 9 shows a diagrammatic view of that end side of the holding device according to FIGS. 7 and 8 which faces a drive in the use position.

### DETAILED DESCRIPTION OF THE PREFERRED EMBODIMENTS

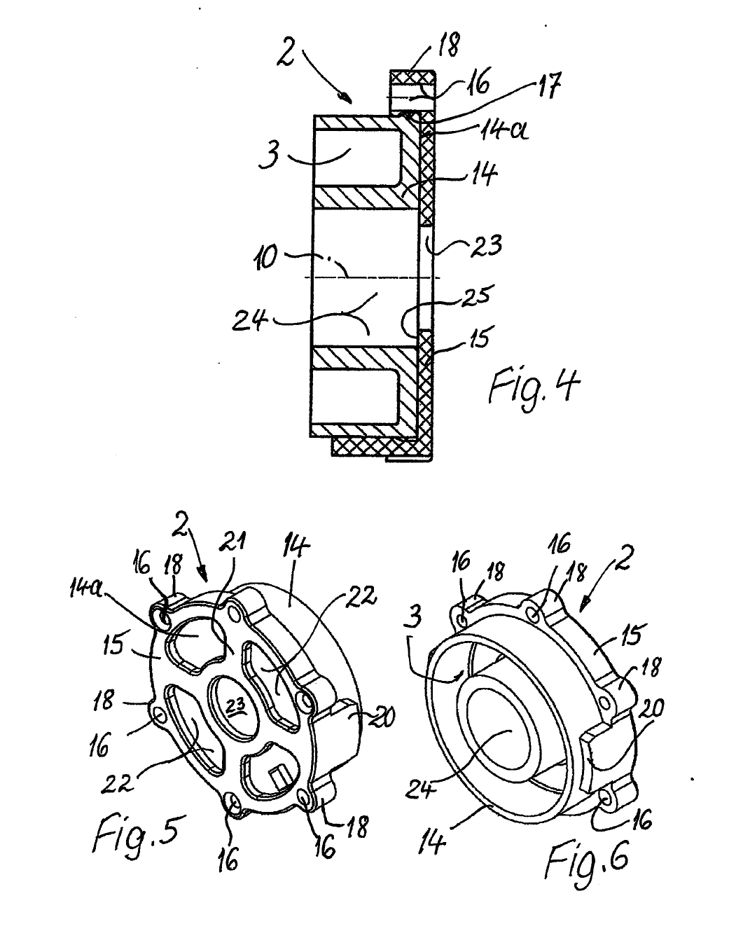

A spring pressure brake which is denoted overall by 1 has a magnet housing 2 which is shown separately in FIGS. 4 to 6. This magnet housing 2 has an annular receiving space 3, also called “annular groove 3”, in which an electromagnetic coil 4 is arranged.

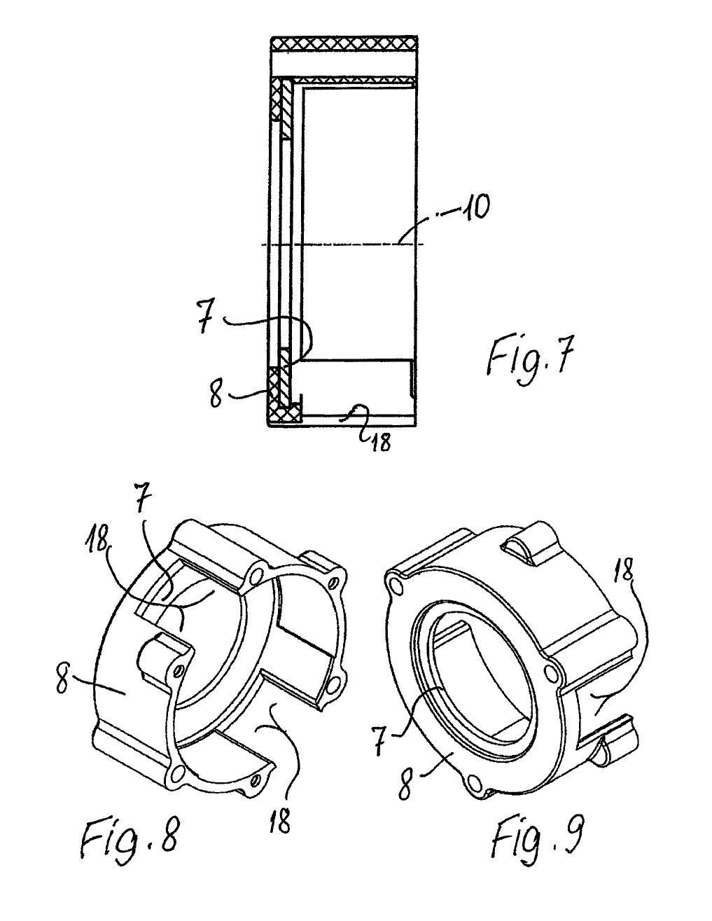

In FIG. 1, the following can be seen: a non-rotatable armature disk 5 which is arranged coaxially with respect to the electromagnetic coil 4 and is made from magnetically conducting material, a rotor disk which is arranged coaxially with respect thereto and serves as brake disk 6, and a mating disk 7 which is once again non-rotatable, serves as abutment for the rotor or brake disk 6, is arranged in a housing-like holding device 8 which encloses it, and is supported in the axial direction by said holding device 8 (see also FIGS. 7 to 9).

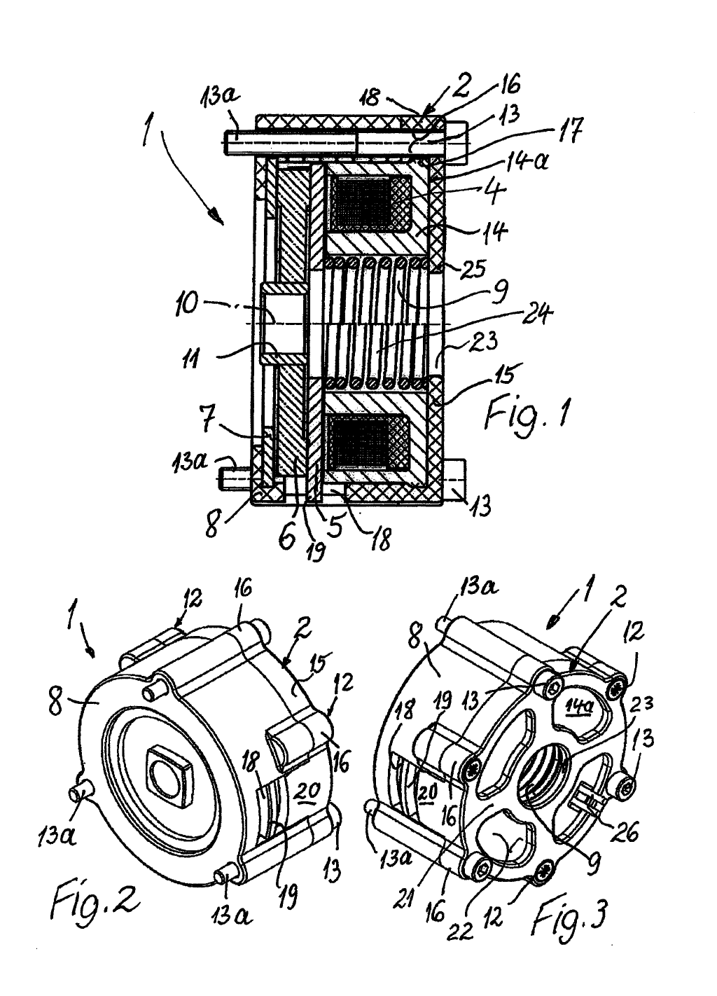

It can be seen clearly in FIG. 1 that said spring pressure brake 1 has a central compression spring 9 which is arranged concentrically with respect to the longitudinal center axis 10 of the overall spring pressure brake 1 and a hub 11 which belongs to the latter, on which hub 11 the brake disk 6 is arranged such that it is connected non-rotatably to it. This compression spring 9 serves to press the brake disk 6 against the mating disk 7 when current is not applied to the electromagnetic coil 4. To this end, the armature disk 5 can be moved away from the electromagnetic coil 4 in the axial direction under the pressure of said compression springs 9, as a result of which the pressure on the brake disk 6 and, as a result, also the mating disk 7 is produced, with the result that the brake is closed and can be opened by current being applied to the coil 4 and the armature disk 5 being pulled back. Here, FIGS. 2 and 3 show fastening screws 12 for connecting the magnet housing 2 to the holding device 8 which serves as receiving housing for the mating disk 7, and, furthermore, fastening screws 13 for connecting the magnet housing 2 to a housing (not shown) of a drive, on the shaft of which, which engages into the hub 11, a braking force is to be capable of being exerted. It can be seen clearly in FIGS. 1 to 3 show said fastening screws 13 protrude axially beyond the holding device 8 in the direction of a drive housing of this type, with the result that said projection 13a can be used for the mentioned fastening.

It can be seen, above all, using FIG. 4, but also using FIG. 1, that the magnet housing 2 is formed of two parts, the first part 14 of which is configured as a pot magnet and is therefore also called “pot magnet 14” in the following text, which has the annular receiving space 3 for the magnetic coil 4. Accordingly, said first part or pot magnet 14 is comprised of magnetizable material and preferably of sintered metal.

As can be seen particularly clearly in FIG. 4, the second part 15 of the magnet housing 2 is connected to the first part 14 and has the fastening points 16 for fastening screws 12 and 13, with the result that said fastening points 16 do not penetrate the magnetizable pot magnet 14, that is to say no magnetizable material is required, in order to receive or to form fastening points 16 of this type. Here, said second part 15 is comprised of non-magnetizable material, with the result that correspondingly little magnetizable material is required overall for the magnet housing 2. Magnetic losses or leakage fluxes can therefore be avoided as far as possible or completely.

Here, that second part 15 of the magnet housing 2 which is connected to the pot magnet 14 is comprised of a material which has a lower specific weight than the material of the pot magnet 14. Here, said non-magnetizable second part 15 of the magnet housing 2, which second part 15 is comprised of a lighter material than the pot magnet 14, also has a lower weight overall, on account of its shape and its dimensions, than the first part or pot magnet 14. The entire arrangement or spring pressure brake 1 can therefore be of weight-saving construction. For example, the non-magnetizable material of the second part 15 of the magnet housing 2 can be a material which can be injection molded, for example plastic or aluminum. As a result, it is possible to connect the first part 14 and the second part 15 of the magnet housing 2 to one another by injection molding.

It is indicated in FIGS. 1 and 4 that, on the circumferential side of the first magnetizable part 14 of the magnet housing 2 close to the end side 14a of said part 14, a region which differs from the contour of said outer side or said cylindrical outer circumference is provided in the form of a projection 17 which engages into the non-magnetizable material of the second part 15 or is embedded therein. Here, said region 16 which differs from a cylindrical contour can also be annularly circumferential or else can be interrupted on the circumference or can be provided with depressions, in order to produce a positively locking connection between the two parts 14 and 15 not only in the axial direction, but also in the radial direction. Here, a “negative projection” could also be provided, into which the material of the second part 15 engages.

The result of FIGS. 2 to 6 is that that second part 15 of the magnet housing 2 which is comprised of non-magnetizable material has, on its outer circumference, projections or cross-sectional widened portions 18 which are oriented in the radial direction for the fastening points 16, which are configured as holes, for fastening screws 12 and 13. Here, the fastening screws 12 are shorter than the fastening screws 13 for fastening the spring pressure brake 1 to a drive housing, because they serve only to connect the magnet housing 2 to the cover-like holding device 8. Here, said holding device 8 for the mating disk 7, which holding device 8 can be connected or is connected to the magnet housing 2 via the screws 12, is likewise comprised of non-magnetizable material, the specific weight of which is lower than that of steel or sintered metal. This contributes to a spring pressure brake 1 being configured with as low a weight as possible.

It can be seen, above all, in FIGS. 7 to 9 that said holding device 8 for the mating disk 7 is configured to be housing-like and as a cover which is connected via the fastening screws 12 to the magnet housing 2 in the use position. An additional connection is a result of the fastening screws 13. Here, said holding device 8 can likewise be comprised of plastic or aluminum and preferably of the same material as the second part 15 of the magnet housing 2.

FIGS. 1 to 3 and 7 to 9 show that the holding device 8 for the mating disk 7 has two openings 18 which run in the axial direction for in each case one projection 19 of the armature disk 5, which in each case one projection 19 engages radially therein, which projections 19 protrude from the armature disk 5 radially to the outside, with the result that the holding device 8 holds the armature disk 5 in a rotationally fixed manner in its use position, the openings 18 having such large dimensions in the axial direction, however, that the armature disk 5 can carry out the required relative axial movement during the actuation of the spring pressure brake 1.

The openings 18 are open in the axial direction for mounting which is as simple as possible and additionally rotationally fixed connection to the magnet housing 2, with the result that the holding device 8 can be plugged onto the magnet housing 2 and mating projections 20 provided thereon.

FIGS. 3 and 5 show that that second part 15 of the magnet housing 2 which is comprised of non-magnetizable material has, on that end side 14a of the pot magnet 14 which is covered by it, a plurality of interruptions 22, between which webs 21 produce the connection to the region which receives the fastening screws 12 and 13. These interruptions 22 which expose the end side 14a facilitate the heat dissipation from the pot magnet 14 and reduce the overall weight. Moreover, the electric feed line 26 to the electromagnetic coil 4 can run through an interruption 22 of this type, as is seen in FIG. 3.

Moreover, it is seen in FIGS. 1, 3, 4 and 5 that that second part 15 of the magnet housing 2 which is arranged on the end side 14a of the pot magnet 14 has a central opening 23 coaxially with respect to the longitudinal center axis 10 of the spring pressure brake 1 and of the pot magnet 14 and with respect to a central opening 24 which penetrates it. Here, the circular cross section or diameter of said opening 23 which is situated on the second part 15 of the magnet housing 2 is smaller than that of the central opening 24 of the spring pressure brake 1 or of the pot magnet 14. It is seen, above all, in FIG. 4 and in FIG. 1 that, as a result, an annular region 25 which projects radially into the region of the central opening 24 is formed, which annular region 25 forms a supporting face for the central compression spring 9 which presses with its side which faces away from said annular region 25 against the armature disk 5.

The spring pressure brake 1 has a magnet housing 2 with an annular space or an annular groove 3 for receiving an electromagnetic coil 4. The magnet housing 2 is formed of two parts, the first part 14 of which has the annular space 3 and is comprised of magnetizable sintered metal, that is to say forms a pot magnet. The second part 15 of the magnet housing 2 encloses a part region of the first part 14 and also its end side 14a and is comprised of a non-magnetizable material, the specific weight of which is lower than that of the material of the first part or pot magnet 14. Magnetic losses can therefore be reduced or avoided and weight can be saved.

1. A spring pressure brake (1) comprising a magnet housing (2) which has an annular receiving space (3) for an electromagnetic coil (4) and is connected by fastening screws (13) to a housing of a drive, a non-rotatable armature disk (5) arranged coaxially with respect to the electromagnetic coil (4) and is made from magnetically conducting material, a rotor disk arranged coaxially with respect to the armature disk and serves as brake disk (6), and a non-rotatable mating disk (7) which serves as abutment for the brake or rotor disk (6), a central compression spring (9) or individual compression springs which are arranged at a radial spacing from a longitudinal center axis (10) in order to generate brake pressure between the armature disk (5), the brake disk (6) and the mating disk (7) when current is not applied to the electromagnetic coil (4), and fastening screws (12), (13) connect the magnet housing (2) to a holding device (8), a housing or a flange for the mating disk, and at least the magnet housing (2) is formed of at least first and second parts, the first part (14) of which has, as pot magnet, the annular receiving space (3) for the magnetic coil (4) and is comprised of magnetizable material, and the second part (15) of the magnet housing (2) is connected to the first part (14), includes fastening points (16) for the fastening screws (13) and is comprised of a non-magnetizable material, said second part (15) of the magnet housing (2) which is comprised of non-magnetizable material having, on an outer circumference, holes or projections or cross-sectional widened portions (18) which are oriented in an axial direction for the fastening screws (13), and the first part (14) of the magnet housing (2) does not have any bores or holes for fastening screws (12).

2. The spring pressure brake as claimed in claim 1, wherein the second part (15) of the magnet housing (2) which is connected to the pot magnet (14) is comprised of a material which has a lower specific weight than a material of the first part (14) of the magnet housing (2).

3. The spring pressure brake as claimed in claim 2, wherein the non-magnetizable second part (15) of the magnet housing (2) which is comprised of a lighter material than the pot magnet (14) has a lower weight than the first part (14) of the magnet housing (2).

4. The spring pressure brake as claimed in claim 1, wherein the non-magnetizable material of the second part (15) of the magnet housing (2) is a material which can be injection molded.

5. The spring pressure brake as claimed in claim 1, wherein the first part (14) of the magnet housing which is comprised of the magnetizable material and the second part (15) of the magnet housing (2) are connected to one another by injection molding.

6. The spring pressure brake as claimed in claim 1, wherein, at least on an outer side or circumferential side of the first magnetizable part (14) of the magnet housing (2), at least one region (17) which differs from a contour of an outer side, from a round or cylindrical contour or a plurality of said regions of this type are provided which engage or are embedded into the non-magnetizable material of the second part (15) in a use position.

7. The spring pressure brake as claimed in claim 1, wherein the second part (15) of the magnet housing (2) which is comprised of the non-magnetizable material has at least one interruption (22) on an end side (14a) of the pot magnet (14) which is covered by it.

8. The spring pressure brake as claimed in claim 7, wherein an electric feed line (26) to the electromagnetic coil (4) runs through an interruption (22), on a lower end side, of the second part (15) of the magnet housing (2).

9. The spring pressure brake as claimed in claim 1 wherein the magnetizable first part (14) of the magnet housing (2) is comprised of sintered metal.

10. The spring pressure brake as claimed in claim 1, wherein the holding device (8), which is connected to the magnet housing (2), for the mating disk (7) is comprised of non-magnetizable material.

11. The spring pressure brake as claimed in claim 10, wherein the holding device is comprised of a material, the specific weight of which is lower than that of steel or sintered metal.

12. The spring pressure brake as claimed in claim 10, wherein the holding device (8) for the mating disk (7) is configured as a cover which is connected to the magnet housing (2) in the use position via at least one of the fastening screws (12) or the fastening screws (13) for the spring pressure brake (1) and is comprised of plastic or aluminum.

13. The spring pressure brake as claimed in claim 12, wherein the holding device is made from the same material as the second part (15) of the magnet housing (2).

14. The spring pressure brake as claimed in claim 1, wherein the holding device (8) for the mating disk (7) has at least one opening (18) which runs in the axial direction for a projection (19), engaging radially therein, of the armature disk (5) or for two openings (18), lying opposite one another on a circumference of the arrangement, for two projections (19) of the armature disk (5) which are aligned with one another, via which the holding device (8) holds the armature disk (5) in the use position.

15. The spring pressure brake as claimed in claim 1, wherein the second part (15) of the magnet housing (2) which is arranged on an end side (14a) of the pot magnet (14) and is made from the non-magnetizable material has a central opening (23) coaxial with respect to the longitudinal center axis (10) of the pot magnet (14) and with respect to a central opening (24) which penetrates therethrough and a circular cross section or diameter of which is smaller than that of the central opening (24) of the spring pressure brake (1), and an annular region (25) of the second part which projects radially in a region of the central opening (24) forms a supporting face for a central compression spring (9).
